(19) United States
(12) Patent Application Publication
(10) Pub. No.: US 2016/0311100 A1
(43) Pub. Date: Oct. 27, 2016

(54) STAPLER WITH BINDING SCALE-PLATE

(71) Applicant: ZUOLIANG WANG, Guangzhou, Guangdong (CN)

(72) Inventor: ZUOLIANG WANG, Guangzhou, Guangdong (CN)

(21) Appl. No.: 15/104,598

(22) PCT Filed: Nov. 6, 2014
(86) PCT No.: PCT/CN2014/090403

§ 371 Date: Jun. 15, 2016

(30) Foreign Application Priority Data
Dec. 18, 2013 (CN) 201310697760.8
Jul. 28, 2014 (CN) 201410362505.2
Sep. 7, 2014 (CN) 201410451420.1

(51) Int. Cl. B25C 7/00; B25C 5/02

(52) U.S. Cl. CPC B25C 7/00; B25C 5/025

(57) ABSTRACT

A stapler with a binding scale-plate includes a base and a staple distortion part grade. The binding scale-plate is designed on the base of the stapler, which can be a single unit or an assembled unit. The binding scale-plate is installed on the stapler base via a rotation axis, and is retrieved to the stapler base when not used and when used, the binding scale-plate is rolled out to one side of the base at a 90-degree angle along the rotation axis. In this way, the binding scale-plate is formed, with the length greater than the width of the base, this will serve as reference for determining binding sites of staples for users.

### BACKGROUND OF THE INVENTION

1. Field of the Invention

This invention relates to a stapler with a binding scale-plate, which belongs to office stationery. It is installed with a binding scale-plate which is retrieved to the stapler base when not used and rolled out when used, and the length of the binding scale-plate is greater than the width of the base. This invention is specifically designed to solve the problems resulting from the lack of effective reference of current staplers, such as: two or more staples are not on the same binding line, and not parallel to a binding edge and differ in distance to binding edge; the distance from staples to the paper edge does not fulfill the binding request.

2. Description of Related Art

Stapler is mainly composed of the binding institution, the base, the staple distortion part. Most of the current staplers are not designed with binding scale-plate which has the function of reference in binding. A few kinds of staplers have binding baffles. But these baffles are too short and without ruler so they cannot function as reference of site restriction and distance. Therefore, the applicant submitted a patent application on “a stapler with binding baffle” (201310697760.8) to the State Intellectual Property Office of the People's Republic of China on Dec. 8, 2013, and two patent applications on “a stapler with binding scale-plate” (201410362505.2, 201410451420.1) on Jul. 28th and Sep. 7th in 2014. Since these are all same technology solutions on this problem, I have merged them together in order to submit international patent application.

### SUMMARY OF THE INVENTION

### Technology Problem

Most of the current staplers are not designed with a binding scale-plate which has the function of reference in binding. The lack of effective reference of current staplers has resulted in the following problems: two or more staples are not on the same binding line, and not parallel to a binding edge and differ in distance to a binding edge; the distance from staples to the paper edge do not fulfill the binding request. This invention is specifically designed to solve these problems. With the premise of not changing the main structure of current staplers, this invention is equipped with a scale-plate which can be rolled out when used and whose length is greater than the width of the base, thus providing users with the function of restricting binding sites and measuring distance.

### Technology Solutions

Technology solutions of this invention: a binding scale-plate is designed on the base of the stapler, which can be a single unit or assembled unit. The binding scale-plate is installed on the stapler base via a rotation axis. It is retrieved to the stapler base when not used and when used, it is rolled out to one side of the base at a 90-degree angle along the rotation axis. In this way, a scale-plate is formed, with the length greater than the width of the base; this will serve as reference for determining binding sites of staples for users. The described binding scale-plate can be designed to be a slab whose length is greater than the width of the base and width smaller than or equal to that of the base, and the rotation axis is fixed in an appropriate position on the base, such as near the staple distortion part. The rotation axis can be designed into a circular ring shape with its diameter longer than the largest diagonal length of the staple distortion part and fixed in the outside of the staple distortion part, while the staple distortion part is within the circular ring of the ring-shaped rotation axis so that the binding scale-plate can be rolled out from the base with the rotation axis as the center to pick up the paper and provide reference for determining the binding sites. The binding scale-plate is comprised of an upper scale-plate and a lower scale-plate which are overlapped when not used and when used, respectively roll out around the rotation axis to the left and right sides of the base at a 90-degree angle to form a binding scale-plate. A track can be designed on the base for the rotation axis to slide forward and backward along the base, and the rotation axis is installed on track, so that the binding scale-plate can move forward and backward on the base with the sliding of the rotation axis, in which way, the distance between binding line and paper edge can be adjusted neatly. The binding scale-plate can be installed on or beneath the base, so two long notches must be designed on both long sides under the base to let the binding scale-plate roll out from the base. When the binding scale-plate can move forward and backward on the base, a baffle can be designed on the binding scale-plate to retain the paper, which can be a bulgy beam on the binding scale-plate or axially connected to the binding scale-plate; the baffle overlaps on the binding scale-plate when not used, and rolls up at a 90-degree angle to be vertical with the binding scale-plate when used, thus possible to retain the paper. The binding scale-plate can be composed of two symmetrical rulers, a left scale-plate and a right scale-plate. A slide is designed on the base and is fixed on the track of the base. The left and right sides of the slide are symmetrically installed to the left and right rotation axes. The left binding scale-plate is connected to the left rotation axis and the right binding scale-plate to the right rotation axis. The left binding scale-plate is retrieved to the left of the base while the right binding scale-plate to the right when not used, and the left binding scale-plate rolls out to the left front along the left rotation axis at a 90-degree angle and the right binding scale-plate to the right front along the right rotation axis at a 90-degree angle when used to form a binding scale-plate. Similarly, the left and the right binding scale-plates both can be designed on and beneath the base. When on the base, the left and right sides of the upper surface of the two long sides of the base can be designed with a symmetrical long notch respectively, while the middle part of the upper surface is a long girder to form a track for the slide to move on the base. The left binding scale-plate is installed in the left notch and the right binding scale-plate in the right notch. The left binding scale-plate can be designed with a left baffle while the right binding scale-plate with a right baffle. The baffles can be bulgy beams on the surfaces of the left and right binding scale-plates or rotatable baffles axially connected to the left and the right binding scale-plates. When the left and the right binding scale-plates are beneath the base, the track can be designed into a new part and installed under the base. The two long sides of the bottom of the base are equipped respectively with a long notch to ensure the left and the right binding scale-plates to roll out from the bottom of the base. In such case, a left baffle which can freely slide upward and downward can be designed behind the left binding scale-plate, and a right baffle behind the right binding scale-plate. The left and the right baffles are behind the left and the right binding scale-plates when not used and when used, slide out upward to bulge from the upper surface of the base to achieve the function of retaining the paper. The above-mentioned stapler base and the binding scale-plate can both be designed with lengthwise graduation, and the binding scale-plate is designed with transverse graduation. The lengthwise graduation provides the users with the distance value between the binding line and the paper edge, while the transverse graduation offers users the distance value between the upper and the lower edges and the central point of staples.

### Advantageous Effect

By means of designing binding scale-plate in stapler, when users are binding files with two or more staples, they can determine the distance value and the parallel relationship between the binding line and the edge of the paper and measure the distance value between the upper and lower edge of the paper and the central point of the staple through the graduation line on the binding scale-plate, thereby binding will be more accurate and convenient; the binding baffle on the binding scale-plate can retain paper and thus neaten and fix paper, solving the mobility of paper when binding, thereby making the binding more rapid and precise; since the binding scale-plate can be retrieved under the base when not used, it won't change the integral structure of current staplers and influence the integral appearance, and the difficulty and cost of production are low.

### BRIEF DESCRIPTION OF DRAWINGS

FIG. 1 is a perspective view of the first embodiment of this invention.

FIG. 2 is a perspective view of user mode of the first embodiment of this invention.

FIG. 3 is a perspective view of the second embodiment of this invention.

FIG. 4 is a perspective view of user mode of the second embodiment of this invention.

FIG. 5 is a perspective view of the third embodiment of this invention.

FIG. 6 is a perspective view of user mode of the third embodiment of this invention.

FIG. 7 is a perspective view of the fourth embodiment of this invention.

FIG. 8 is a perspective view of user mode of the fourth embodiment of this invention.

FIG. 9 is a perspective view of user mode of the fifth embodiment of this invention.

FIG. 10 is a perspective view of the sixth embodiment of this invention.

FIG. 11 is a perspective view of user mode of the sixth embodiment of this invention.

FIG. 12 is a perspective view of user mode of the seventh embodiment of this invention.

FIG. 13 is a perspective view of the eighth embodiment of this invention.

FIG. 14 is a perspective view of user mode of the eighth embodiment of this invention.

FIG. 15 is a perspective view of user mode of the ninth embodiment of this invention.

FIG. 16 is a perspective view of the tenth embodiment of this invention.

FIG. 17 is a perspective view of user mode of the tenth embodiment of this invention.

FIG. 18 is a perspective view, after disassembling the binding scale-plate, of user mode of the tenth embodiment of this invention.

FIG. 19 is a perspective view of the eleventh embodiment of this invention.

FIG. 20 is a perspective view of user mode of the eleventh embodiment of this invention.

FIG. 21 is a perspective view, after disassembling the binding scale-plate, of user mode of the eleventh embodiment of this invention.

FIG. 22 is a perspective view of user mode of the twelfth embodiment of this invention.

### DETAILED DESCRIPTION OF THE PREFERRED EMBODIMENTS

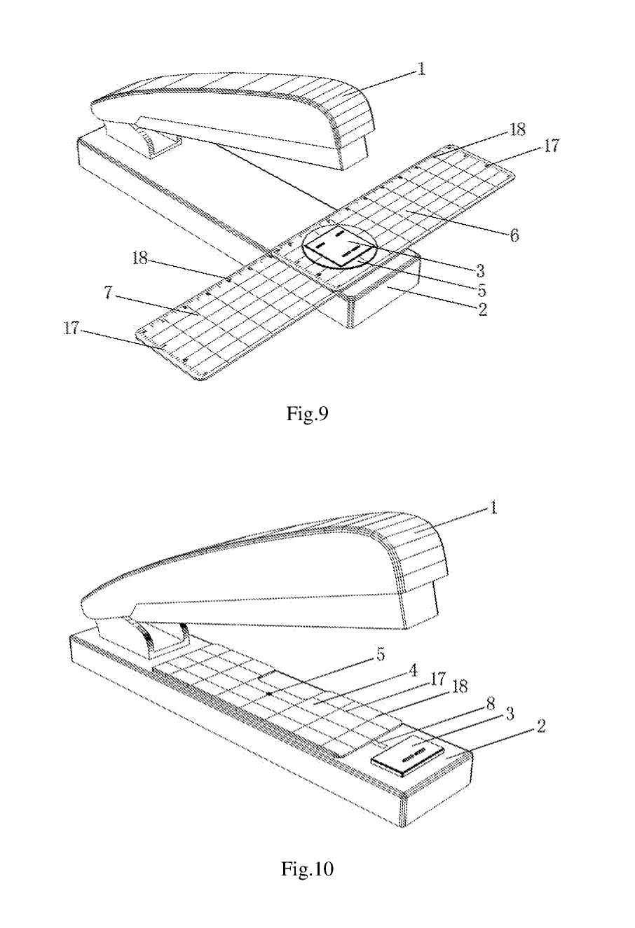

Refer to FIG. 9. FIG. 9 is the perspective view of user mode of the fifth embodiment of this invention. This embodiment is the preferred embodiment of this invention where the binding scale-plate includes upper and lower layers and is installed in the outside of the staple distortion part 3. The rotation axis 5 can be designed into a circular ring shape with its diameter longer than the largest diagonal length of the staple distortion part 3 and fixed in the outside of the staple distortion part 3. The staple distortion part 3 is within the circular ring of the ring-shaped rotation axis 5. The upper scale-plate 6 and lower scale-plate 7 are overlapped when not used and when used, respectively roll out along the rotation axis 5 to the left and right sides of the base at a 90-degree angle to form a binding scale-plate. This embodiment considers not only the least alteration of the appearance of the stapler and the convenience and rapidness of utility, but also the initial design intention of the binding scale-plate, providing users with sufficient binding convenience to a great extent. At the same time, it adequately considers simplicity of production and installation and the request of low cost.

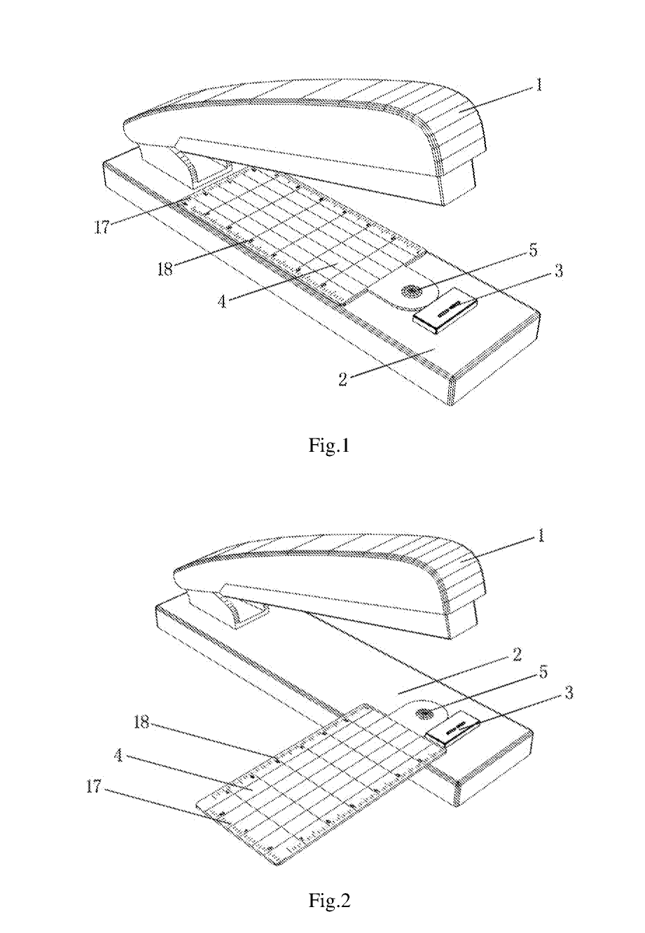

Refer to FIG. 1 and FIG. 2. FIG. 1 is the perspective view of the first embodiment of this invention. FIG. 2 is the perspective view of user mode of the first embodiment of this invention. The binding scale-plate 4 is installed on the stapler base 2. The binding scale-plate 4 is a slab whose length is greater than the width of the base and width smaller than or equal to that of the base. The binding scale-plate 4 is fixed on the base 2 via the rotation axis 5. The binding scale-plate 4 can be retrieved to the base 2 when not used and when used, rolled out to one side of the base at a 90-degree angle along the rotation axis 5 to form binding scale-plate 4 with the length greater than the width of the base. This embodiment is the most fundamental embodiment of the design thought of this invention. It is comprised of a binding scale-plate and a rotation axis, with the rotation axis fixed near the staple distortion part.

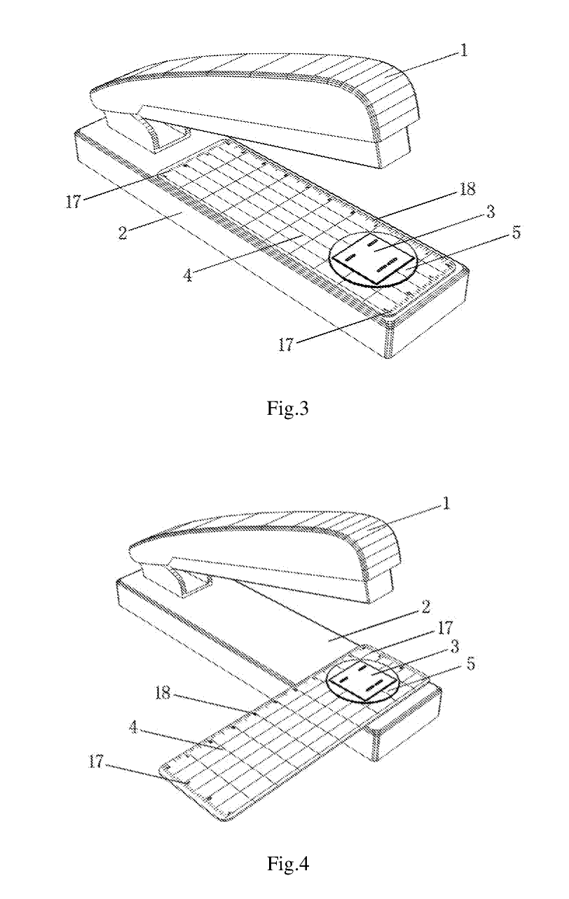

Refer to FIG. 3 and FIG. 4. FIG. 3 is the perspective view of the second embodiment of this invention. FIG. 4 is the perspective view of user mode of the second embodiment of this invention. In this embodiment, the rotation axis 5 is fixed in the outside of the staple distortion part 3. The rotation axis 5 is in a circular ring shape with its diameter longer than the largest diagonal length of the staple distortion part 3 and fixed in the outside of the staple distortion part 3. And the staple distortion part 3 is within the circular ring of the ring-shaped rotation axis 5.

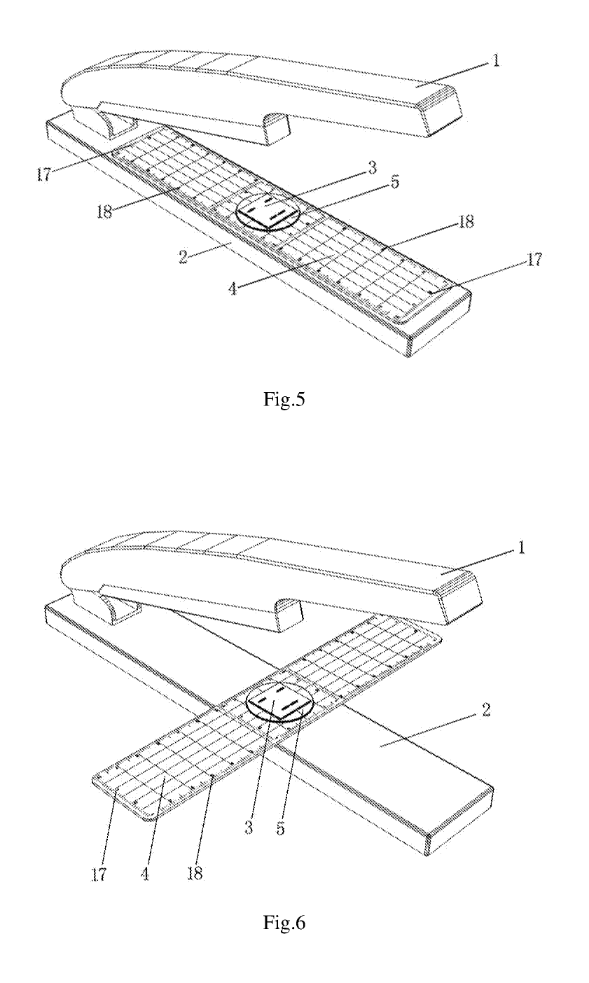

Refer to FIG. 5 and FIG. 6. FIG. 5 is the perspective view of the third embodiment of this invention. FIG. 6 is the perspective view of user mode of the third embodiment of this invention. This embodiment is based on the second embodiment. It is the proposed technology solution for the lengthened heavy stapler. In the diagram, the stapler base 2 and binding arm become twice as long in order to be more convenient for thick-layer binding, and the binding scale-plate 4 correspondingly becomes twice as long. The rotation axis 5 is in the middle of the binding scale-plate 4 so that when the binding scale-plate 4 rolls out it can provide users with reference of binding sites simultaneously in the left and right sides of the stapler base 2. Since the binding scale-plate 4 is longer, it will be more sufficient and convenient to provide users with the distance value between the upper and the lower paper edges and the central point of staples and more accurate to determine the parallel relationship between the binding line and the edge of the paper.

In order to use the same-length binding scale-plate as the third embodiment in ordinary small staplers, the binding scale-plate can be designed into two layers on the basis of the first and second embodiments. These two layers are overlapped when not used and when used, respectively roll out to the left and right sides of the base at a 90-degree angle respectively to form a binding scale-plate.

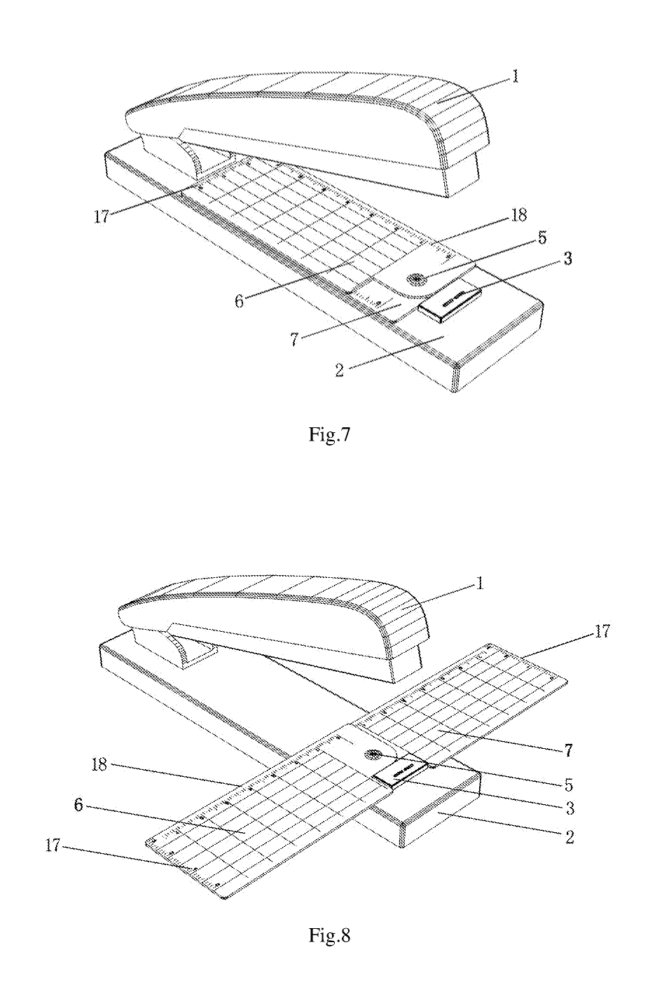

Refer to FIG. 7, FIG. 8 and FIG. 9. FIG. 7 is the perspective view of the fourth embodiment of this invention. FIG. 8 is the perspective view of user mode of the fourth embodiment of this invention. FIG. 9 is the perspective view of user mode of the fifth embodiment of this invention. The fourth embodiment is on the basis of the first embodiment, where the binding scale-plate is designed into two layers. The fifth embodiment is on the basis of the second embodiment, where the binding scale-plate is designed into two layers. It is shown in FIG. 7, FIG. 8 and FIG. 9 that, the binding scale-plate 4 is comprised of the upper scale-plate 6 and the lower scale-plate 7. They are overlapped when not used and when used, the upper scale-plate 6 and the lower scale-plate 7 respectively roll out around the rotation axis 5 to the left and right sides of the base at a 90-degree angle to form the binding scale-plate 4.

Width of most stapler bases is 3 to 5 centimeters. The binding scale-plates designed according to the described embodiments can provide users with a binding line distance reference of 2 to 4 centimeters, while the distance of binding line is generally 1.75 centimeters for most paper edge binding; that is to say, the described embodiment has already satisfied most binding requests. But there also exists something not convenient: mainly because of the binding scale-plate is fixed but the distance of binding line is not, no baffle has been designed that can retain the paper. Therefore, during binding the parallel relationship between the binding line and the edge of the paper is determined by the users referring to the graduation lines on the binding scale-plate. The mobility of paper will result in that it is not easy to be accurate in determining the parallel relationship between the upper and lower staples and the edge of the paper edge and that the binding is not fast enough; what's more, the distance of binding line is limited, which cannot satisfy binding requests of a longer distance of binding line.

In order to solve the described problems, it is necessary to design a binding scale-plate whose location can be adjusted and design a baffle which can retain paper to make the binding more rapid and to satisfy more extensive binding requests.

Refer to FIG. 10 and FIG. 11. FIG. 10 is the perspective view of the sixth embodiment of this invention. FIG. 11 is the perspective view of user mode of the sixth embodiment of this invention. In this embodiment, the track 8 for the rotation axis 5 to slide forward and backward on the base 2 is on the stapler base 2. The rotation axis 5 is fixed on the track 8. The binding scale-plate 4 can move forward and backward on the base 2 with the sliding of the rotation axis 5. This embodiment is the fundamental embodiment of the design thought of this invention that the binding scale-plate 4 can move forward and backward on the base 2. Because the binding scale-plate 4 of this embodiment can only be installed between the staple distortion part 3 and the joint of the binding institution 1 and the base 2, its length is only about half of the length of the base.

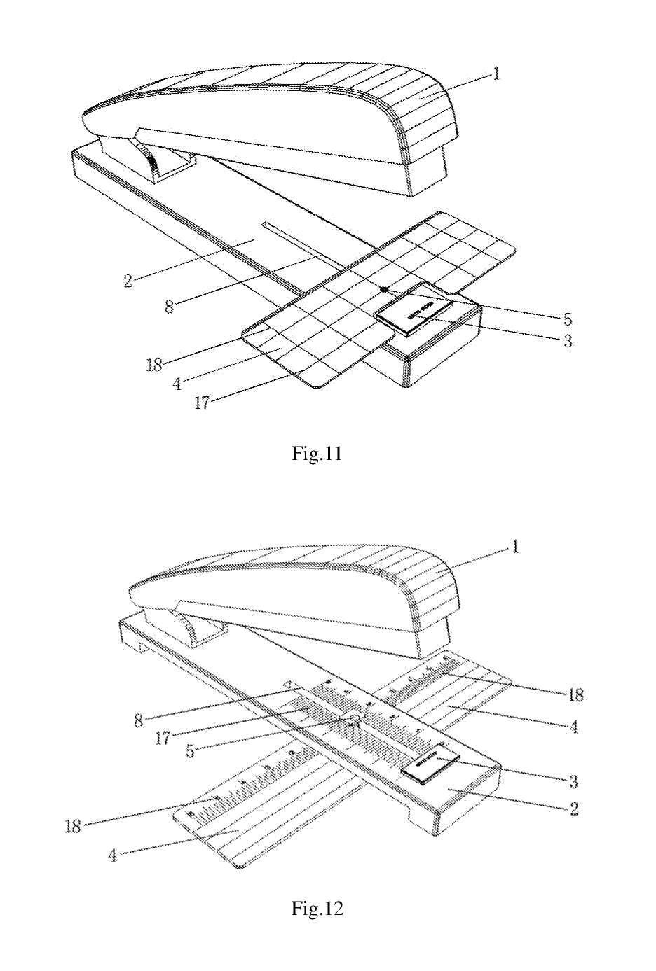

In order to have a longer binding scale-plate, the binding scale-plate that can move forward and backward on the base 2 may be installed under the base 2. Refer to FIG. 12. FIG. 12 is the perspective view of user mode of the seventh embodiment of this invention. In this embodiment, the binding scale-plate 4 is installed beneath the base 2. Two long notches are designed on both long sides under the base 2 to let the binding scale-plate 4 roll out from the base 2. In this way, the length of the designed binding scale-plate 4 is only a little shorter than the base 2, and it provides reference of binding sites in a more accurate and sufficient manner.

Since the binding scale-plate can move forward and backward on the base, the distance of the binding line can be adjusted thought adjusting the location of the binding scale-plate on the base. In this way, a baffle can be designed that can retain paper on the binding scale-plate. The baffle is paralleled with the binding line during binding. The parallel relationship between the binding line and the paper edge can be ensured simply by adjoining the paper with the baffle. Under the assistance of the baffle, the paper can be neatened and fixed, thus solving the mobility of paper when binding and making the binding more rapid and accurate.

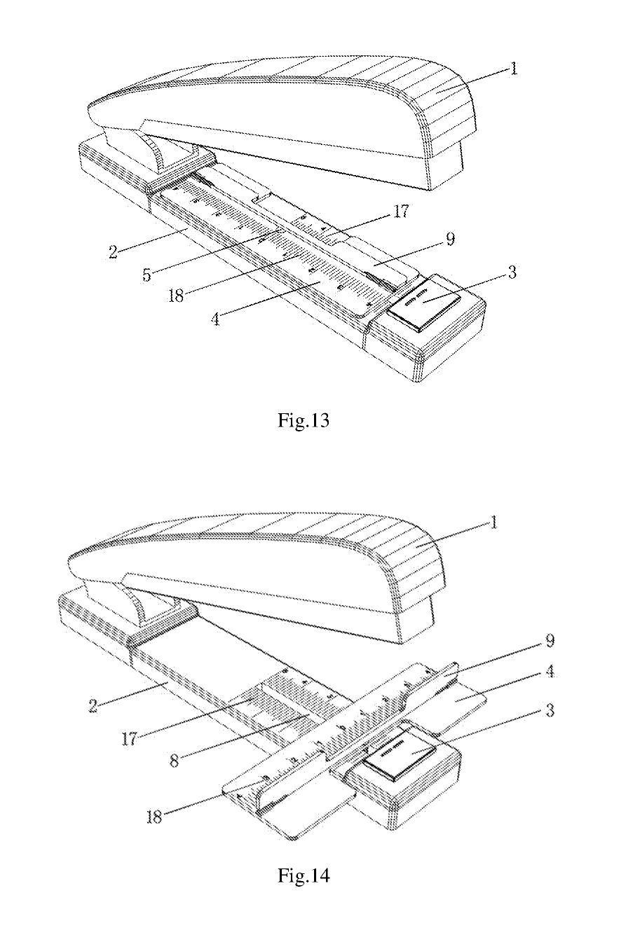

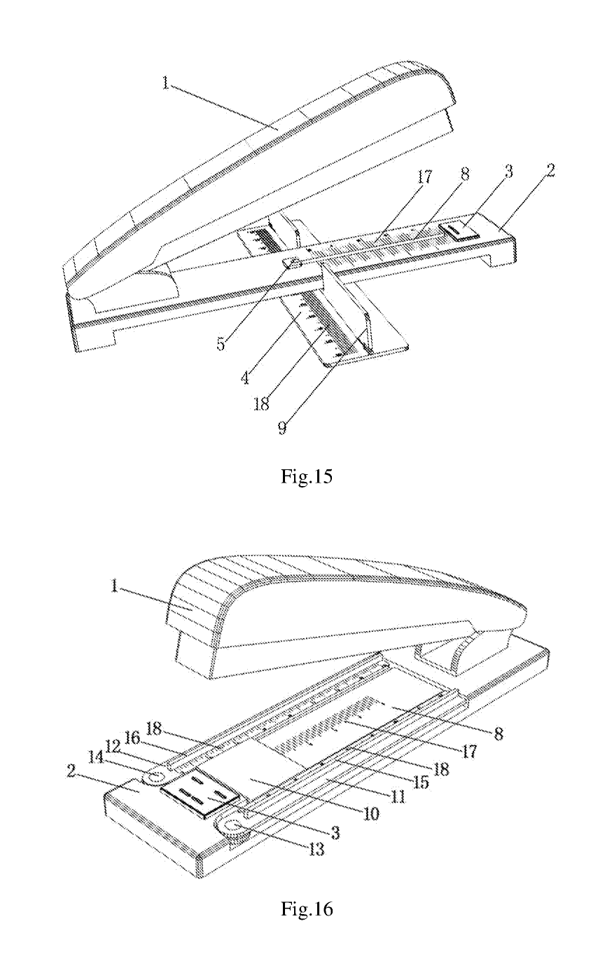

Refer to FIG. 13, FIG. 14 and FIG. 15. FIG. 13 is the perspective view of the eighth embodiment of this invention. FIG. 14 is perspective view of user mode of the eighth embodiment of this invention. FIG. 15 is the perspective view of user mode of the ninth embodiment of this invention. A baffle is fixed on the binding scaleplate in the eighth embodiment on the basis of the sixth embodiment. A baffle is fixed on the binding scale-plate in the ninth embodiment on the basis of the seventh embodiment. Refer to FIG. 13, FIG. 14 and FIG. 15. The baffle 9 is fixed on the binding scale-plate 4, and one side of the baffle 9 is axially connected to the binding scale-plate 4. The baffle 9 overlaps on the binding scale-plate 4 when not used, and when used, the baffle 9 rolls up at a 90-degree angle to be vertical with the binding scale-plate 4, thus possible to retain the paper when binding.

The length of an A4 official document paper is 29.7 centimeters. If two staples are used on the one third of the long side, the distance between the two staples and the upper and the lower paper edges will be about 10 centimeters respectively. As the length of the base of a current common stapler is about 12 to 14 centimeters, and the stapler designed according to the ninth embodiment has a longer binding scale-plate, the total length of whom can reach up to 10 to 12 centimeters, and the measured distance of the left and right sides is 5 to 6 centimeters, the measurement request of 10 centimeters cannot be satisfied. Therefore, the technology solution of designing overlapped left and right binding scale-plates is proposed as follows.

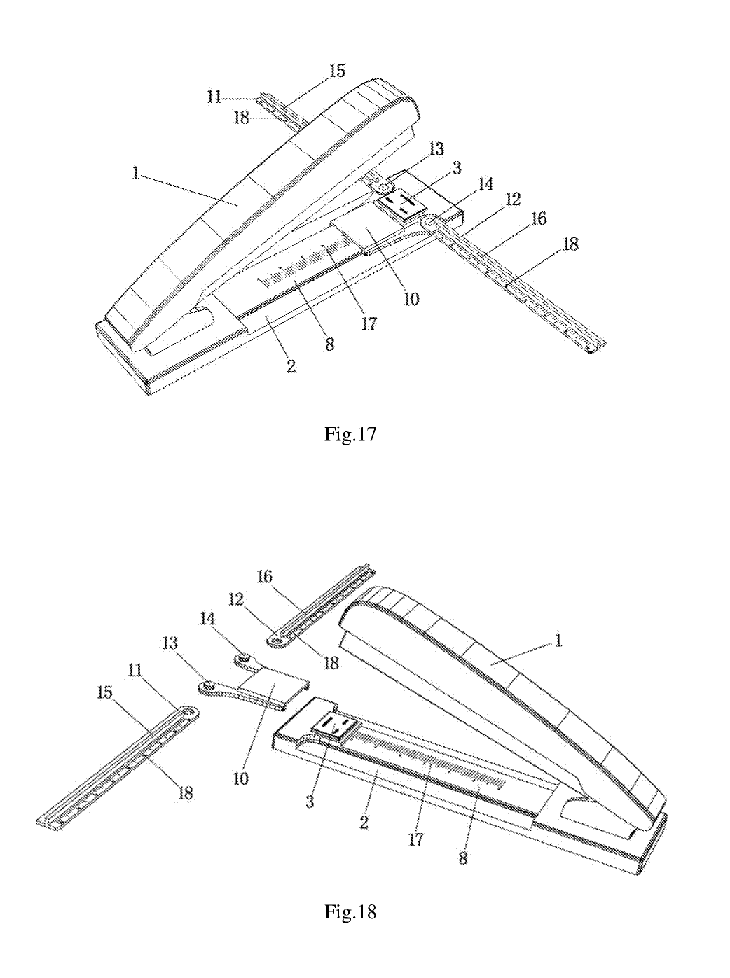

Refer to FIG. 16, FIG. 17 and FIG. 18. FIG. 16 is the perspective view of the tenth embodiment of this invention. FIG. 17 is the perspective view of user mode of the tenth embodiment of this invention. FIG. 18 is the perspective view, after disassembling the binding scale-plate, of user mode of the tenth embodiment of this invention. Refer to FIG. 16, FIG. 17 and FIG. 18. In this embodiment, the binding scale-plate 4 is comprised of two symmetrical scale-plate—the left binding scale-plate 11 and the right binding scale-plate 12. A slide 10 is designed on the base 2 and is fixed on the track 8 of the base 2. The left and right sides of the slide 10 are symmetrically installed to the left rotation axis 13 and the right rotation axis 14. The left binding scale-plate 11 is connected to the left rotation axis 13 and the right binding scale-plate 12 to the right rotation axis 14. The left binding scale-plate 11 is retrieved to the left of the base 2 while the right binding scale-plate 12 to the right of the base 2 when not used, and when used, the left binding scale-plate 11 rolls out to the left front along the left rotation axis 13 at a 90-degree angle and the right binding scale-plate 12 to the right front along the right rotation axis 14 at a 90-degree angle to form a binding scale-plate with a total length up to 20 centimeters, in order to satisfy the measurement request of users of the 10-centimeter distance between the upper and lower paper edges and the central point of staples.

Refer to FIG. 16, FIG. 17 and FIG. 18. The track 8 is on the base 2. The left and right sides of the upper surface of the two long sides of the base 2 respectively have a symmetrical long notch, while the middle part of the upper surface is a long girder to form the track 8. The left binding scale-plate 11 is installed in the left notch and the right binding scale-plate 12 in the right notch. The left binding scale-plate 11 can be designed with the left baffle 15 while the right binding scale-plate 12 with the right baffle 16. The left baffle 15 and the right baffle 16 can be bulgy beams on the surfaces of the left binding scale-plate 11 and the right scale-plate 12 or the same structure as the baffle 9 in the eighth and the ninth embodiments, namely, rotatable baffles axially connected to the left binding scale-plate 11 and the right scale-plate 12 (Fig. omitted).

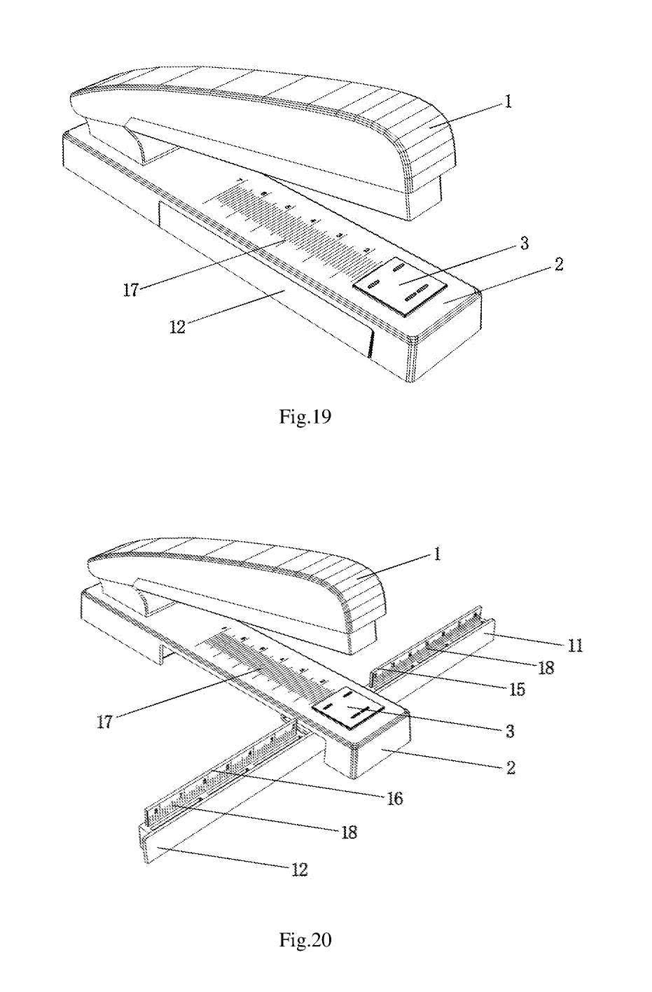

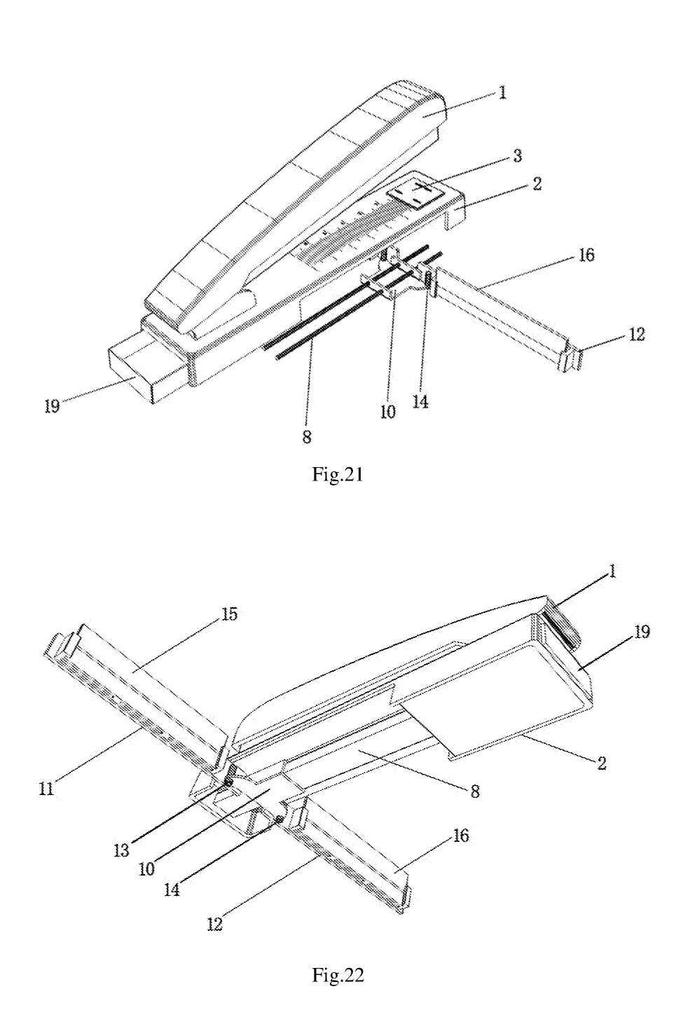

Similarly, the left and the right binding scale-plates can be designed beneath the base: Refer to FIG. 19, FIG. 20, FIG. 21 and FIG. 22. FIG. 19 is the perspective view of the eleventh embodiment of this invention. FIG. 20 is the perspective view of user mode of the eleventh embodiment of this invention. FIG. 21 is the perspective view, after disassembling the binding scale-plate, of user mode of the eleventh embodiment of this invention. FIG. 22 is the perspective view of user mode of the twelfth embodiment of this invention. Refer to FIG. 21 and FIG. 22. The track 8 of the eleventh and the twelfth embodiments is a new part installed under the base 2. The two long sides of the bottom of the base 2 are equipped respectively with a long notch to ensure the left binding scale-plate 11 and the right binding scale-plate 12 to roll out from the bottom of the base 2. The design of the eleventh and the twelfth embodiments is the same other than the different design of the track 8. The track 8 of the eleventh embodiment in FIG. 21 is comprised of two circular tubes, which are connected to the front and back ends of the base 2 and paralleled with the central axis of the base. The track 8 of the twelfth embodiment in FIG. 22 is a long sliding track fixed on the central axis of the base 2. Refer to FIG. 21 and FIG. 22. Since the binding scale-plate does not need to be too long, and the height of the stapler base produced according to this embodiment will be higher than most of current staplers, in order to enhance the practicability of the stapler, the staple box 19 is designed in the back-end of the base 2. Refer to FIG. 20, FIG. 21 and FIG. 22. The left baffle 15 is glidingly connected behind the left scale-plate 11 and the right baffle 16 is glidingly connected behind the right scale-plate 12. The left baffle 15 and the right baffle 16 are behind the left binding scale-plate 11 and the right binding scale-plate 12 when not used and when used, slide out upward to bulge from the upper surface of the base 2. Refer to FIG. 19. In this embodiment, the outer planes of the left and right binding scale-plates and the plane where the outer edges of the two long sides of the stapler base lie are in the same plane, and the size and the shape of the left and right binding scale-plates are the same with the long notches of the long sides of the base. The left and right binding scale-plates are overlapped and retrieved under the base when not used, and inosculate with the base, becoming parts of the base. Therefore, it will not influence the overall appearance of the base.

By comparing the figures, it can also be shown that the stapler base 2 and the binding scale-plate 4 of these embodiments of this invention can be designed with lengthwise graduation 17, and the binding scale-plate 4 is designed with transverse graduation 18. The lengthwise graduation 17 takes the central point of the deformation groove of the staple distortion part as the start point scale 0 and provides users with the distance value between the binding line and the edge of the paper. The transverse graduation 18 takes the central point of the deformation groove of the staple distortion part as the start point scale 0 and offers users the distance value between the upper and the lower paper edges and the central point of staples. Refer to FIG. 14, FIG. 15 and FIG. 17. The baffle on the binding scale-plate separates the scale-plate into two parts—the front and the back. The part in front of the baffle retains the paper when binding, and transverse graduation is printed on the back part of the scale-plate. It will be convenient for users to read the distance value. Refer to FIG. 20. It can be seen that transverse graduation 18 is printed on the baffle.

### INDUSTRY PRACTICABILITY

This invention adequately considers the humanization request of industrial design, achieving beautiful appearance, reliable structure and simple operation, and expanding the function of staplers without changing people's habit when binding with a stapler; this invention increases the standardization of file binding, and satisfies the technology request of binding a file with two or more staples, making the binding more accurate and rapid, enhancing the efficiency of office work and realizing great practicability; without changing the integral structure of the current staplers, the binding institution of this invention employs the current general units, and the new part has the advantages of simple structure, low performance index requirement, basically all can use of plastic materials, the production of technical is low-difficulty, low cost, and favorable for popularization.

1. A stapler with a binding scale-plate comprising a base and a staple distortion part, wherein the binding scale-plate is disposed on the base of the stapler, which can be a single unit or an assembled unit, the binding scale-plate is installed on the base via a rotation axis, and is retrieved to the base when not used and when used, the binding scale-plate is rolled out to one side of the base at a 90-degree angle along the rotation axis, in this way, the binding scale-plate is formed, with the length greater than the width of the base, thereby to serve as reference for determining binding sites of staples for users.

2. The stapler of claim 1, wherein the binding scale-plate described is a slab whose length is greater than the width of the base and width smaller than or equal to that of the base, the rotation axis is fixed to the base.

3. The stapler of claim 2, wherein the rotation axis can be designed into a circular ring shape with a diameter longer than the largest diagonal length of the staple distortion part, fixed in an outside of the staple distortion part, the staple distortion part is within the circular ring of the ring-shaped rotation axis.

4. The stapler of claim 2, wherein the described binding scale-plate is comprised of an upper scale-plate and a lower scale-plate which are overlapped when not used and respectively roll out along the rotation axis to the left and right sides of the base at a 90-degree angle to form the binding scale-plate.

5. The stapler of claim 1, wherein the track can be designed on the base for the rotation axis to slide forward and afterward along the base, the rotation axis is installed on the track, and the binding scale-plate may move forward and backward on the base with the sliding of the rotation axis.

6. The stapler of claim 5, wherein the binding scale-plate can be installed beneath the base, so two long notches must be designed on both long sides under the base to let the binding scale-plate to roll out from the base.

7. The stapler of claim 6, wherein the baffle can be designed on the binding scale-plate; the baffle can be axially connected to the binding scale-plate; the baffle overlaps on the binding scale-plate when not used, and when used, the baffle rolls up at a 90-degree angle to be vertical with the binding scale-plate, thus possible to retain the paper.

8. The stapler of claim 1, wherein the binding scale-plate can be composed of two symmetrical scale-plates, the left scale-plate and the right scale-plate; a slide is designed on the base and is fixed on the track of the base; the left and right sides of the slide are symmetrically installed to the left rotation axis and right rotation axis; the left binding scale-plate is connected to the left rotation axis and the right binding scale-plate to the right rotation axis; the left binding scale-plate is retrieved to the left of the base while the right binding scale-plate to the right rotation axis when not used, and when used, the left binding scale-plate rolls out to the left front along the left rotation axis at a 90-degree angle and the right binding scale-plate to the right front along the right rotation axis at a 90-degree angle to form a binding scale-plate.

9. The stapler of claim 8, wherein when the track is on the base, the left and right sides of the upper surface of the two long sides of the base can be designed with a symmetrical long notch respectively, while the middle part of the upper surface is a long girder to form a track; the left binding scale-plate is installed in the left notch and the right binding scale-plate is installed in the right notch.

10. The stapler of claim 8, wherein the left binding scale-plate can be designed with a left baffle while the right binding scale-plate with a right baffle; the left baffle and the right baffle can be bulgy beams on the surface of the left binding scale-plate and the right binding scale-plate respectively or rotatable baffles axially connected to the left binding scale-plate and the right binding scale-plate.

11. The stapler of claim 8, wherein the track is a new part and installed under the base; two long sides of the bottom of the base are equipped respectively with a long notch to ensure the left binding scale-plate and the right binding scale-plate to roll out from the bottom of the base.

12. The stapler of claim 11, wherein the left baffle is glidingly connected behind the left binding scale-plate, and the right baffle is glidingly connected behind the right binding scale-plate; the left baffle and the right baffle are behind the left binding scale-plate and the right binding scale-plate when not used and when used, slide out upward to bulge from the upper surface of the base.

13. The stapler of claim 1, wherein there is lengthwise graduation on the base or binding scale-plate; there is transverse graduation on the binding scale-plate; the lengthwise graduation provides users with the distance value between the binding line and the edge of the paper; the transverse graduation offers users the distance value between the upper and the lower paper edges and the central point of staples.
